(19) United States
(12) Patent Application Publication
(10) Pub. No.: US 2022/0019189 A1
(43) Pub. Date: Jan. 20, 2022

(54) SYSTEMS AND METHODS FOR UTILIZING INTERNET CONNECTED SENSORS FOR MANUFACTURE MONITORING

(71) Applicant: Honeywell International Inc., Morris Plains, NJ (US)

(72) Inventor: Ryan M. KRENZ, Phoenix, AZ (US)

(21) Appl. No.: 16/928,099

(22) Filed: Jul. 14, 2020

(51) Int. Cl. G05B 19/406

(52) U.S. Cl. CPC G05B 19/406; G05B 2219/32197

(57) ABSTRACT

According to certain aspect of the disclosure, a computer-implemented method may be used for manufacturing monitoring using internet connected devices. The method may include receiving time series data from one or more sensors located at a manufacturing location and receiving environmental data from the one or more sensors located at a manufacturing location. Additionally, the method may include receiving quality data of one or more components produced at the manufacturing location and receiving production data of the one or more components produced at the manufacturing location. Additionally, the method may include associating the time series data and the environmental data with the quality data and production data of the one or more components produced at the manufacturing location; and displaying the associated time series data, environmental data, quality data and production data on a user device.

### TECHNICAL FIELD

Various embodiments of the present disclosure generally relate to a supply chain monitoring using connected devices, and more particularly, to integrating connected devices for monitoring in a manufacturing environment.

### BACKGROUND

Manufacturers of goods that involve assembling the goods from a number of components are constrained by the limited time available to optimally plan and track the components. These manufacturers may have a number of suppliers producing the components and delivering the components to the manufacturer. In the current environment of supply chain the manufacturers may have suppliers in different parts of the country or even different parts of the world. However, up until now collecting data of the components from the suppliers have involved manual inputs, and often times after the components have been produced. Managing components produced by discrete manufacturing may encounter several challenges such as lack of sufficient data related to the production of the components, or difficulties in tracking qualities of the components produced, or delay in receiving relevant data. The present disclosure is directed to overcoming one or more of these issues.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF DISCLOSURE

According to certain aspects of the disclosure, systems and methods are disclosed to provide data regarding manufacturing of components via internet connected devices located remotely in manufacturing locations.

In one embodiment, a computer-implemented method may be used for manufacturing monitoring using internet connected devices. The method may include receiving, by a one or more processors, time series data from one or more sensors located at a manufacturing location; receiving, by the one or more processors, environmental data from the one or more sensors located at a manufacturing location; receiving, by the one or more processors, quality data of one or more components produced at the manufacturing location; receiving, by the one or more processors, production data of the one or more components produced at the manufacturing location; associating, by the one or more processors, the time series data and the environmental data with the quality data and production data of the one or more components produced at the manufacturing location; and displaying, by the one or more processors, the associated time series data, environmental data, quality data and production data on a user device.

According to another aspect of the disclosure, a computer-implemented system for manufacturing monitoring using internet connected devices may include at least one memory having processor-readable instructions stored therein; and at least one processor configured to access the memory and execute the processor-readable instructions, which when executed by the processor configures the processor to perform a plurality of functions. The functions may include receiving time series data from one or more sensors located at a manufacturing location; receiving environmental data from the one or more sensors located at a manufacturing location; receiving quality data of one or more components produced at the manufacturing location; receiving production data of the one or more components produced at the manufacturing location; associating the time series data and the environmental data with the quality data and production data of the one or more components produced at the manufacturing location; and displaying the associated time series data, environmental data, quality data and production data on a user device.

According to still another aspect of the disclosure, a non-transitory computer-readable medium containing instructions for manufacturing monitoring using internet connected devices, the non-transitory computer-readable medium storing instructions that, when executed by at least one processor, may configure the at least one processor to perform receiving, by the one or more processors, time series data from one or more sensors located at a manufacturing location; receiving, by the one or more processors, environmental data from the one or more sensors located at a manufacturing location; receiving, by the one or more processors, quality data of one or more components produced at the manufacturing location; receiving, by the one or more processors, production data of the one or more components produced at the manufacturing location; associating, by the one or more processors, the time series data and the environmental data with the quality data and production data of the one or more components produced at the manufacturing location; and displaying, by the one or more processors, the associated time series data, environmental data, quality data and production data on a user device.

Additional objects and advantages of the disclosed embodiments will be set forth in part in the description that follows, and in part will be apparent from the description, or may be learned by practice of the disclosed embodiments. It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment in which systems, methods, and other aspects of the present disclosure may be implemented.

FIG. 2 depicts an exemplary user interface for capturing component data from internet connected devices.

FIG. 3 depicts an exemplary flow chart of capturing component data from internet connected devices.

FIG. 4 depicts an exemplary computer device or system, in which embodiments of the present disclosure, or portions thereof, may be implemented

### DETAILED DESCRIPTION OF EMBODIMENTS

As discussed above, managing discrete manufacturing supply chain may encounter numerous challenges. Discrete manufacturing is the production of distinct items, and may be characterized by individual or separate unit production. Units may be produced in low volume with very high complexity or high volumes of low complexity. The processes deployed in discrete manufacturing may not be continuous as each process may be individually started or stopped and can be run at varying production rates. The final product may be produced out of single or multiple inputs. Thus the challenges related to discrete manufacturing may include improving product quality and time-to-market speed while minimizing costs, inventory controls, product lead times and reducing or limiting material costs and waste.

Therefore, a need exist to remedy the above discussed shortcomings by installing internet connect devices located at each production facility to capture data that may be used to pre-stich quality and production data to time-series data based on date-time sequencing. The pre-stich data may be utilized to improve product quality, assist in maintaining proper inventory controls, and reduce costs and waste.

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

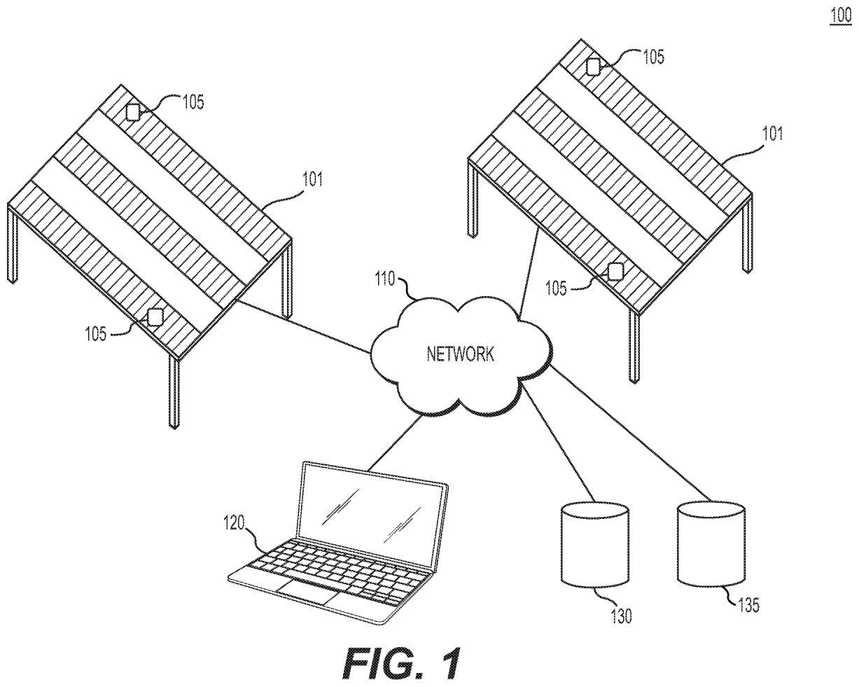

Referring now to the appended drawings, FIG. 1 depicts an exemplary environment 100 in which systems, methods, and other aspects of the present disclosure may be implemented. Environment 100 may include one or more manufacturing facilities 101, the one or more manufacturing facilities 101 may be facilities that produce parts or components, or may be facilities that assemble produced parts or components into products. Each of the manufacturing facilities 101 may have one or more sensors 105 installed. Sensors 105 may be used to capture data related to the manufacturing process and data related to the components or parts. Data collected by the sensors 105 may include environmental data, for example temperature, humidity, or any other appropriate environmental data. Sensors 105 may also collect time series data (e.g., date and time of production), quality data (e.g., pass inspection or faulty parts) and production data. Environment 100 may also include network 110, user device 120, time series database 130, and quality and production database 135. The user device 120, manufacturing facilities 101 and databases 130 and 135 may be connected via network 110. Network 110 may be any suitable network or combination of networks and may support any appropriate protocol suitable for communication of data between various components in the system environment 100. The network 110 may include a public network (e.g., the Internet), a private network (e.g., a network within an organization), or a combination of public and/or private networks.

The user device 120 may be operated by one or more users to perform data stitching and data monitoring and evaluation. Examples of user device 120 may include smartphones, wearable computing devices, tablet computers, laptops, and desktop computers.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1.

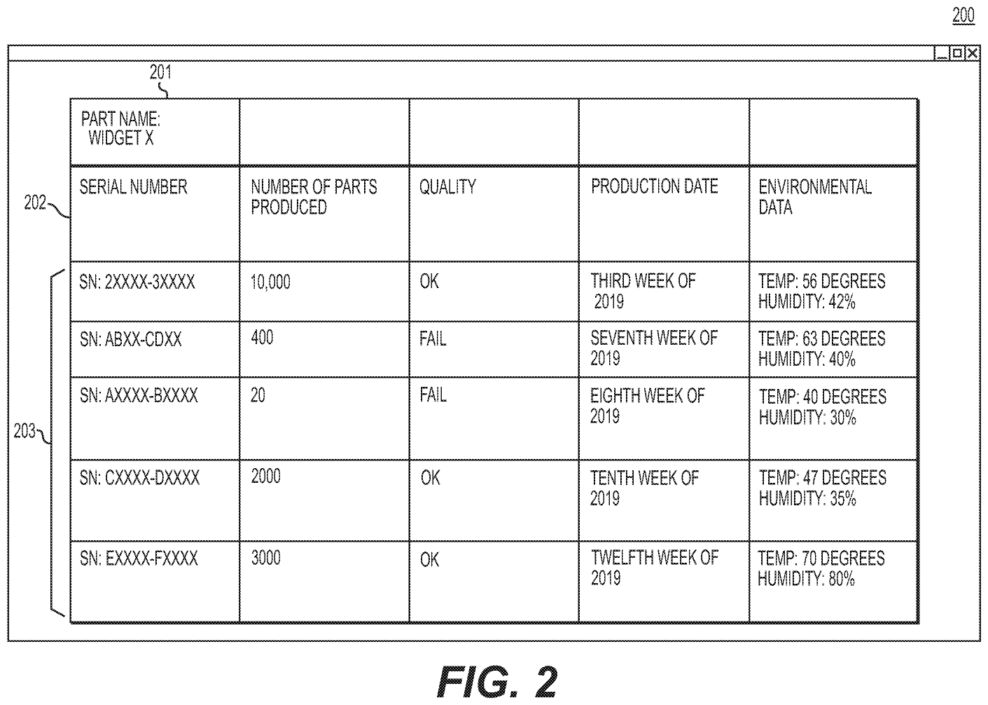

FIG. 2 depicts an exemplary user interface 200 for capturing component data from internet connected devices. User interface 200 may be displayed on the user device 120. User interface 200 may be an application that receives captured data from sensors 105 located in the manufacturing facilities and stitch or combine the collected data to enable users to monitor and evaluate the manufacturing facilities. User interface 200 may include identification 201 of the produced component. The identification of the component may be a component name, a code name, or an alphanumeric identification assigned to the component. The user interface 200 may also include a title bar 202, and detail data area 203. The title bar 202 may include serial number of the component, production data such as number of the components produced, quality data, time-series data such as production date and type of the component, and environmental data.

The detail data area 203 may display data collected from the one or more sensors 105 and pre-stitched together to offer details of the components produced. For example, for the serial number range of “2xxxx-3xxxx” of the part “Widget X”, the production data sensor may have collected data to indicate that there were 10,000 total components produced between the serial number range and the components were produced during the third production week of 2019. The environmental sensor may have collected environmental data during the third production week of 2019 to indicate that the temperature of the manufacturing facility was at 56 degrees with 42% humidity. The quality sensor may have collected quality data during production of the components for serial number range “2xxxx-3xxxx” and the quality data indicates that the components passed the quality check. As another example, for the serial number range of “ABxx-CDxx” of component “Widget X” the production data sensor may have collected data to indicate that there were 400 total components produced between the serial number range and the components were produced during the seventh production week of 2019. The environmental sensor may have collected environmental data during the seventh production week of 2019 to indicate that the temperature of the manufacturing facility was at 63 degrees with 40% humidity. The quality sensor may have collected quality data during production of the components for serial number range “ABxx-CDxx” and the quality data indicates that the components failed quality check.

The user interface 200 displaying detailed components data pre-stitched from data collected from multiple sensors may offer the user or an supply chain manager numerous benefits in evaluating the manufacturing processes and controlling the production of the components. For example, the user may conclude from the data that the quantity of “Widget X” dropped for the tenth and twelfth production weeks of 2019 compared to the third production week of 2019. The user may also conclude that environmental factors may have contributed to the quality failure of “Widget X” during the seventh and eighth production week of 2019. In another embodiment, the data may be captured in real-time from the sensors located in manufacture facilities and transmitted to the user interface 200. The user operating the user device 120 may identify issues or faults from the real-time data and respond accordingly to improve product quality, maintain proper inventory controls, and reduce costs and waste. For example, if the data captured by the sensors are indicating that the components are failing quality check, the user may decide to pause the manufacturing line until a resolution can be implemented to minimizing waste. As another example, if the data captured by the sensors are indicating that the components are not being produced in sufficient quantities, the user may decide to increase production shifts or bring up any idling production lines to increase quantities produced.

In another embodiment, user interface 200 may be used to manually enter data by the user. For example, it may be determined after “Widget X” has been produced that the components were faulty, the user may determine the serial number of the faulty components and enter the appropriate data into user interface 200. User interface 200 may then look up the associated production data and environmental data and display the detail data in user interface 200. For example, if components within serial number range “Axxxx-Bxxxx” were determined to be faulty after being produced, the user may enter the serial number and quality data and the user interface 200 may display that “Widget X” within serial number range “Axxxx-Bxxxx” were produced during the eighth production week of 2019, the temperature of the manufacturing facility during the eighth production week was 40 degrees with 30% humidity, and a total of 20 “Widget X” were produced within the serial number range.

The user interface layout shown in FIG. 2 are provided as an example. In practice, there may be additional user interface elements, fewer user interface elements, different user interface elements, or differently arranged user interface elements than those shown in FIG. 2.

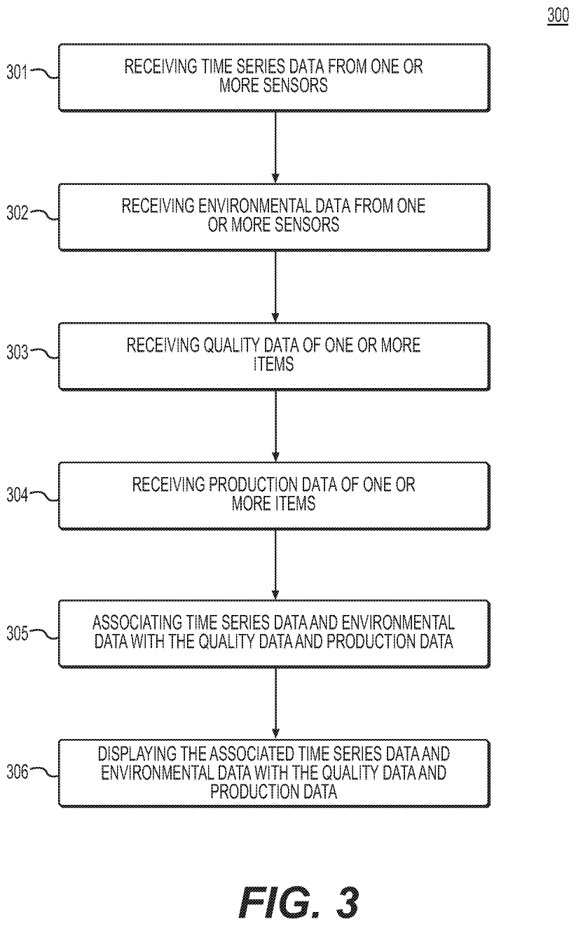

FIG. 3 depicts an exemplary flow chart 300 for capturing component data from internet connected devices. Flow chart 300 may begin at step 301 by receiving time series data from the one or more sensors installed at the one or more manufacturing facilities. At step 302, environmental data collected from the one or more sensors installed at the one or more manufacturing facilities may be received. At step 303, quality data of the one or more components may be received. The quality data may be transmitted from the one or more sensors installed at the one or more manufacturing facilities, or may be received from other sources. At step 304, production data of the one or more components may be received. The production data may be transmitted from the one or more sensors installed at the one or more manufacturing facilities, or may be received from other sources. At step 305, the received time series data and environmental data may be associated with the quality data and production data. The association process may be performed to link the quality and production data with the time series and environmental data. For example, components produced within a certain batch or serial number range may be associated with quantity produced, quality of the produced components, date and time of the production, and environmental factors. At step 306, the associated time series data and environment data with the quality data and production data may be displayed to a user. An example of the association process and display may be represented by the exemplary FIG. 2.

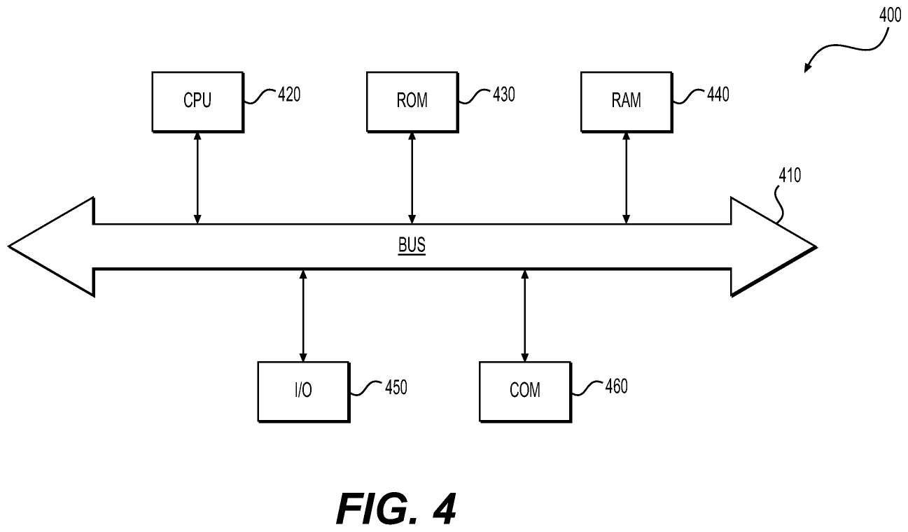

FIG. 4 depicts a high-level functional block diagram of an exemplary computer device or system, in which embodiments of the present disclosure, or portions thereof, may be implemented, e.g., as computer-readable code. In some implementations, the user device 120 may correspond to device 400. Additionally, each of the exemplary computer servers, databases, user interfaces, modules, and methods described above with respect to FIGS. 1-3 can be implemented in device 400 using hardware, software, firmware, tangible computer readable media having instructions stored thereon, or a combination thereof and may be implemented in one or more computer systems or other processing systems. Hardware, software, or any combination of such may implement each of the exemplary systems, user interfaces, and methods described above with respect to FIGS. 1-3.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor “cores.”

Various embodiments of the present disclosure, as described above in the examples of FIGS. 1-3, may be implemented using device 400. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 4, device 400 may include a central processing unit (CPU) 420. CPU 420 may be any type of processor device including, for example, any type of special purpose or a general-purpose microprocessor device. As will be appreciated by persons skilled in the relevant art, CPU 420 also may be a single processor in a multi-core/multiprocessor system, such system operating alone, or in a cluster of computing devices operating in a cluster or server farm. CPU 420 may be connected to a data communication infrastructure 410, for example, a bus, message queue, network, or multi-core message-passing scheme.

Device 400 also may include a main memory 440, for example, random access memory (RAM), and also may include a secondary memory 430. Secondary memory 430, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 430 may include other similar means for allowing computer programs or other instructions to be loaded into device 400. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 400.

Device 400 also may include a communications interface (“COM”) 460. Communications interface 460 allows software and data to be transferred between device 400 and external devices. Communications interface 460 may include a modem, a network interface (such as an Ethernet card), a communications port, a PCMCIA slot and card, or the like. Software and data transferred via communications interface 460 may be in the form of signals, which may be electronic, electromagnetic, optical, or other signals capable of being received by communications interface 460. These signals may be provided to communications interface 460 via a communications path of device 400, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 400 also may include input and output ports 450 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It is intended that the specification and examples be considered as exemplary only, with a true scope and spirit of the disclosure being indicated by the following claims.

What is claimed is:

1. A computer-implemented method for manufacturing monitoring using internet connected devices, the method comprising:
receiving, by a one or more processors, time series data from one or more sensors located at a manufacturing location;
receiving, by the one or more processors, environmental data from the one or more sensors located at a manufacturing location;
receiving, by the one or more processors, quality data of one or more components produced at the manufacturing location;
receiving, by the one or more processors, production data of the one or more components produced at the manufacturing location;
associating, by the one or more processors, the time series data and the environmental data with the quality data and production data of the one or more components produced at the manufacturing location; and
displaying, by the one or more processors, the associated time series data, environmental data, quality data and production data on a user device.

2. The computer-implemented method of claim 1, further including,
identifying, by the one or more processors, one or more faults based on the associated time series data, environmental data, quality data and production data;
displaying, by the one or more processors, notifications of the one or more faults on the user device; and
displaying, by the one or more processors, an indication on the user device upon remediation of the one or more faults.

3. The computer-implemented method of claim 1, wherein the displaying the associated time series data, environmental data, quality data and production data on a user device further include filtering the associated data based on at least one of time series data, environmental data, quality data or production data.

4. The computer-implemented method of claim 1, wherein the quality data and production data are stored according to a serial number of the component.

5. The computer-implemented method of claim 1, wherein the environmental data includes at least one of temperature or humidity;

6. The computer-implemented method of claim 1, wherein the production data includes at least one of number of components manufactured, manufacture date and time of the components, or manufacture rate of the components.

7. The computer-implemented method of claim 1, wherein the time series data, environmental data, quality data and production data are stored in one or more databases located remotely from the manufacturing location.

8. A computer-implemented system for manufacturing monitoring using internet connected devices, the computer-implemented system comprising:
a memory having processor-readable instructions stored therein; and
at least one processor configured to access the memory and execute the processor-readable instructions, which when executed by the processor configures the processor to perform a plurality of functions, including functions for:
receiving time series data from one or more sensors located at a manufacturing location;
receiving environmental data from the one or more sensors located at a manufacturing location;
receiving quality data of one or more components produced at the manufacturing location;
receiving production data of the one or more components produced at the manufacturing location;
associating the time series data and the environmental data with the quality data and production data of the one or more components produced at the manufacturing location; and
displaying the associated time series data, environmental data, quality data and production data on a user device.

9. The computer system of claim 8, wherein the functions further include:
identifying one or more faults based on the associated time series data, environmental data, quality data and production data;
displaying notifications of the one or more faults on the user device; and
displaying an indication on the user device upon remediation of the one or more faults.

10. The computer system of claim 8, wherein the displaying the associated time series data, environmental data, quality data and production data on a user device further include filtering the associated data based on at least one of time series data, environmental data, quality data or production data.

11. The computer system of claim 8, wherein the quality data and production data are stored according to a serial number of the component.

12. The computer system of claim 8, wherein the environmental data includes at least one of temperature or humidity;

13. The computer system of claim 8, wherein the production data includes at least one of number of components manufactured, manufacture date and time of the components, or manufacture rate of the components.

14. The computer system of claim 8, wherein the time series data, environmental data, quality data and production data are stored in one or more databases located remotely from the manufacturing location.

15. A non-transitory computer-readable medium containing instructions for manufacturing monitoring using internet connected devices, comprising:
receiving, by a one or more processors, time series data from one or more sensors located at a manufacturing location;
receiving, by the one or more processors, environmental data from the one or more sensors located at a manufacturing location;
receiving, by the one or more processors, quality data of one or more components produced at the manufacturing location;
receiving, by the one or more processors, production data of the one or more components produced at the manufacturing location;
associating, by the one or more processors, the time series data and the environmental data with the quality data and production data of the one or more components produced at the manufacturing location; and
displaying, by the one or more processors, the associated time series data, environmental data, quality data and production data on a user device.

16. The non-transitory computer-readable medium of claim 15, further including,
identifying, by the one or more processors, one or more faults based on the associated time series data, environmental data, quality data and production data;
displaying, by the one or more processors, notifications of the one or more faults on the user device; and
displaying, by the one or more processors, an indication on the user device upon remediation of the one or more faults.

17. The non-transitory computer-readable medium of claim 15, wherein the displaying the associated time series data, environmental data, quality data and production data on a user device further include filtering the associated data based on at least one of time series data, environmental data, quality data or production data.

18. The non-transitory computer-readable medium of claim 15, wherein the quality data and production data are stored according to a serial number of the component.

19. The non-transitory computer-readable medium of claim 15, wherein the environmental data includes at least one of temperature or humidity;

20. The non-transitory computer-readable medium of claim 15, wherein the production data includes at least one of number of components manufactured, manufacture date and time of the components, or manufacture rate of the components.
